(19) United States
(12) Patent Application Publication
(10) Pub. No.: US 2007/0004433 A1
(43) Pub. Date: Jan. 4, 2007

(54) Cellular phone base and a wireless earphone capable of switching cellular phone and cordless phone communications

(76) Inventor: Yueh Wen Hsiang, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/516,478

(22) Filed: Sep. 7, 2006

Related U.S. Application Data
(63) Continuation-in-part of application No. 10/406,203, filed on Apr. 4, 2003, now abandoned.

(51) Int. Cl. H04Q 7/20

(52) U.S. Cl. 455/462

(57) ABSTRACT

A cellular phone base capable of switching cellular phone and cordless phone communications is disclosed. The cellular phone base comprises a telephone interface connected to a telephone line; a cellular phone interface connected to a cellular phone; a control unit installed in the cellular phone base; a transceiver unit connected to the control unit, the transceiver unit being under control of the control unit and communicating with a corresponding wireless earphone; and at least one switch connected to the telephone interface, the cellular phone interface, the control unit, and the transceiver unit, wherein the switch normally connects the transceiver unit with the cellular phone interface, and when the telephone interface is connected to the control unit, a signal is sent to the control unit to switch the switch such that the transceiver unit is connected to the telephone interface.

### CROSS-REFERENCE TO RELATED APPLICATIONS

This application is a Continuation-in-Part of application Ser. No. 10/406,203, filed on 4 Apr. 2003, and entitled CELLULAR PHONE BASE AND A WIRELESS EARPHONE CAPABLE OF SWITCHING CELLULAR PHONE AND CORDLESS PHONE.

### 1. FIELD OF THE INVENTION

The present invention relates to a cellular phone base and a wireless earphone capable of switching cellular phone and cordless phone communications. More particularly, the present invention relates to a portable transceiver device capable of switching cellular phone and cordless phone communications.

### 2. DESCRIPTION OF THE PRIOR ART

The major advantage of a cellular phone is its high portability. When using a cellular phone in a car, in order to recharge its internal battery and also so that the car's antenna can be used to increase communicating efficiency, the cellular phone is usually connected to the car through a socket built in the lower part of the cellular phone and a signal cable provided by the telephone vendor. Once the cellular phone is connected to the car, the phone will automatically disconnect its internal antenna and connect its telephone circuit to the car antenna. Typically, the cellular phone is powered by plugging into an electric cigarette lighter. Plugs can be directly plugged into some electrical devices whereas connecting devices are needed for certain other electrical devices. Electrical devices that lack a connecting device must be small but may still often seriously interfere with operation of parts of the car such as the stick shift. Hitherto, no prior art has disclosed a cellular phone base and a wireless earphone capable of switching cellular phone and cordless phone communications.

### SUMMARY OF THE INVENTION

The main objective of the invention is to provide a cellular phone base and a wireless earphone capable of switching cellular phone and cordless phone communications.

For achieving the objects stated above, a cellular phone base comprises a telephone interface connected to a telephone line; a cellular phone interface connected to a cellular phone; a control unit installed in the cellular phone base; a transceiver unit connected to the control unit, the transceiver unit being under control of the control unit and communicating with a corresponding wireless earphone; and a plurality of electric switches connected to the telephone interface, the cellular phone interface, the control unit, and the transceiver unit, wherein the electric switches normally connects the transceiver unit with the cellular phone interface, and when a voice signal is sent to the control unit via the telephone through the telephone interface, a central controller controls the electric switches such that the transceiver unit is connected to the telephone interface.

From one aspect of the present invention, a wireless earphone capable of switching cellular phone and cordless phone communications is disclosed. The wireless earphone comprises an input device for inputting voice signals; a control unit installed in the wireless earphone; a switching unit connected to the control unit, wherein when the switching unit is pressed, voice volume and frequency channels can be adjusted; a keypad unit connected to the control unit, the keypad unit comprising a plurality of buttons; a transceiver unit connected to the input device and the control unit, the transceiver unit being under control of the control unit and communicating with a corresponding cellular phone base; and an output device connected to the control unit, wherein the output device is used to transmit signals received by the transceiver unit under the control of the control unit.

Other objects, advantages and novel features of the invention will become more clearly and readily apparent from the following detailed description when taken in conjunction with the accompanying drawings.

### BRIEF DESCRIPTION OF THE DRAWINGS

FIG. 1 is a block diagram illustrating the circuit of a cellular phone base 1 according to the present invention;

FIG. 2 is a block diagram illustrating the circuit of a telephone interface; and

FIG. 3 is a circuit block diagram of the wireless earphone 2 according to the present invention.

### DETAILED DESCRIPTION OF THE PREFERRED EMBODIMENT

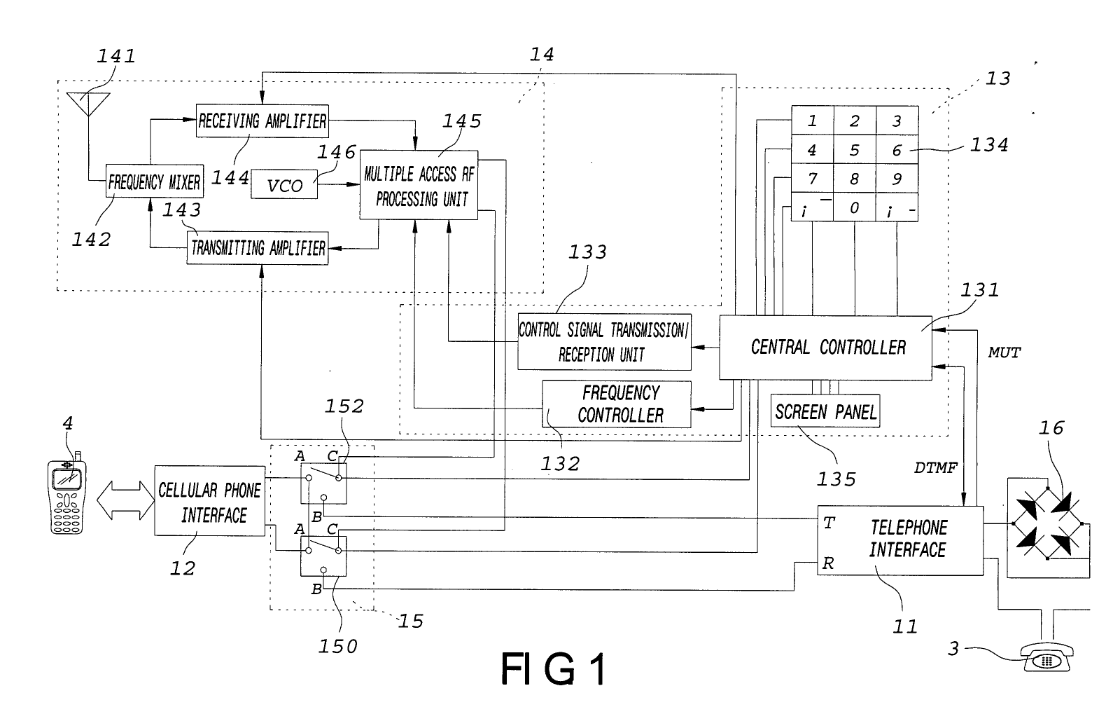

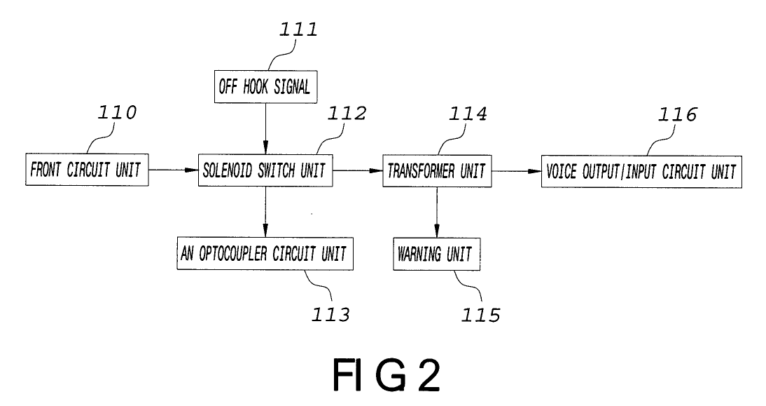

Please refer to FIG. 1 and FIG. 2. FIG. 1 is a block diagram illustrating the circuit of a cellular phone base 1 according to the present invention. FIG. 2 is a block diagram illustrating the circuit of a telephone interface. The cellular phone base 1 comprises a telephone interface 11, a cellular phone interface 12, a control unit 13, a transceiver unit 14, and a plurality of electric switches 15.

An inside circuit of the telephone interface 11 further comprises a front circuit unit 110, a solenoid switch unit 112, an optocoupler circuit unit 113, a transformer unit 114, a warning unit 115, and a voice output/input circuit unit 116. The telephone interface 11 can be produced by a single chip. The electric switches 15 are a first electric switch 150 and a second electric switch 152 that are designed with a, b and c contacts, individually.

The front circuit unit 110 receives a voice signal by a telephone line. The voice signal is rectified by a rectifying circuit 16 in order to be outputted on the solenoid switch unit 112 and the optocoupler circuit unit 113. The optocoupler circuit unit 113 notifies the user of a telephone signal inputted via various voice transmitters from the warning unit 115. When the user picks up the receiver an off hook signal is sent to the solenoid switch unit 112. The solenoid switch unit 112 transmits the voice signal to the transformer unit 114. Finally, the transformer unit 114 makes the voice signal stronger and transmits the voice signal to the voice output/input circuit unit 116 for outputting/inputting.

The telephone interface 11 is electrically connected to a typical telephone line of a telephone 3 through a rectifying circuit 16 for receiving voice signals. The telephone 3 may be a cordless telephone or a cable telephone. A voice input terminal of the voice output/input circuit unit 116 is electrically connected to a terminal R of the telephone interface 11 that is electrically connected to a contact B of the first electric switch 150. A voice output terminal of the voice output/input circuit unit 116 is electrically connected to a terminal T of the telephone interface 11 that is electrically connected to the contact B of the second electric switch 152.

The cellular phone interface 12 is connected to a portable cellular phone 4 and a contact A of the first electric switch 150 and a contact A of the second electric switch 152. Normally, the contact C is connected to the contact A of the first electric switch 150 and the contact C is connected to the contact A of the second electric switch 152. Through the contact C being connected to the contact A of the first electric switch 150 and the contact C being connected to the contact A of the second electric switch 152, the voice signals sent from the cellular phone 4 can be transmitted to the control unit 13 of the cellular phone base 1. Alternatively, signals can be sent from the cellular phone base 1 through the control unit 13 to the portable cellular phone 4. The cellular phone interface 12 can be a Bluetooth protocol interface. The control unit 13 consists of a central controller 131, a frequency controller 132, and a control signal transceiver section 133. The control unit 13 is the kernel of the cellular phone base 1.

In addition, the central controller 131 of the control unit 13 further comprises a keyboard input part 134 having a plurality of keys and a display panel 135 for dialing and displaying.

The transceiver unit 14 is connected to the control unit 13. The transceiver unit 14 comprises an antenna 141, a SAW filter 142, a transmitting amplifier 143, a receiving amplifier 144, a multiple-access RF processing unit 145, and a voltage control oscillator (VCO) 146. The transceiver unit 14 is controlled by the control unit 13 and communicates with a wireless earphone 2. However, the wireless earphone 2 includes a communication transmission password. A user inputs the correct communication transmission password via the keyboard input part 134. The central controller 131 of the control unit 13 transmits a communication signal to the transmitting amplifier 143 of the transceiver unit 14 when the communication transmission password is correct during transmission.

The SAW filter 142 receives the communication signal from the transmitting amplifier 143 through the antenna 141 for transmission to the wireless earphone 2. The multiple-access RF processing unit 145 is electrically connected to the voltage control oscillator 146, the receiving amplifier 144, the transmitting amplifier 143, the control signal transceiver section 133, and the frequency controller 132. The multiple-access RF processing unit 145 receives the voltage control signal of the voltage control oscillator 146, the output signal of the receiving amplifier 144, the output signal of the control signal transceiver section 133, the output signal of the frequency controller 132, and the signal transmitted from the central control 131.

The contact A of the first electric switch 150 and the contact A of the second electric switch 152 are electrically connected to the cellular phone interface 12 individually. The contact B of the first electric switch 150 is electrically connected to the terminal R of the telephone interface 11 and the contact B of the second electric switch 152 is electrically connected to the terminal T of the telephone interface 11. The contact C of the first electric switch 150 and the contact C of the second electric switch 152 is electrically connected to the central controller 131 and the multiple-access RF processing unit 145.

The operating manner of the cellular phone base 1 is explained below. The central controller 131 of the control unit 13 is always on standby status for receiving voice signals transmitted from a telephone 3 or a cellular phone 4. The telephone interface 11 transmits an MUT signal and a DTMF signal to the central controller 131 for generating a telephone control signal when the telephone 3 transmits the voice signal to the rectifying circuit 16 through the telephone line. The terminal R of the telephone interface 11 transmits the voice signal to the contact B of the first electric switch 150 and the terminal T of the telephone interface 11 simultaneously transmits the voice signal to the contact B of the second electric switch 152. The telephone interface 11 receives the telephone control signal for driving the contact C connected to the contact B of the first electric switch 150 and the contact C connected to the contact B of the second electric switch 152 so that the cellular phone interface 12 will be disable.

The telephone interface 11 transmits the voice signal to the multiple-access RF processing unit 145. The multiple-access RF processing unit 145 transmits the voice signal to the transmitting amplifier 143 for amplification via the output signal of the control signal transceiver section 133, the frequency controller 132 and the receiving amplifier 144. The amplified voice signal is transmitted to an SAW filter 142 for outputting frequency filter action. The antenna 141 transmits the filtered voice signal to the wireless earphone 2. When the communication is finished, the contact C disconnects from the contact B of the first electric switch 150 and the second electric switch 152 and changes to the contact C electrically connected with the contact A of the first electric switch 150 and the second electric switch 152.

The cellular phone interface 12 receives the voice signal from the portable cellular phone 4 that a call is being transmitted. The voice signal will be transmitted to the central controller 131 and the multiple-access RF processing unit 145 because of the contact C and the contact A of the first electric switch 150 and the second electric switch 152. The voice signal is transmitted to a transceiver unit 25 of the wireless earphone 2 controlled by the central controller 131.

Two switches 15 are electrically connected to the telephone interface 11, the cellular phone interface 12, the control unit 13, and the transceiver unit 14. There are joints a, b, and c in the two switches 15. Normally, the joint c is connected to the joint a. In this case, the multiple-access RF processing unit 145 of the transceiver unit 14 is connected to the cellular phone interface 12.

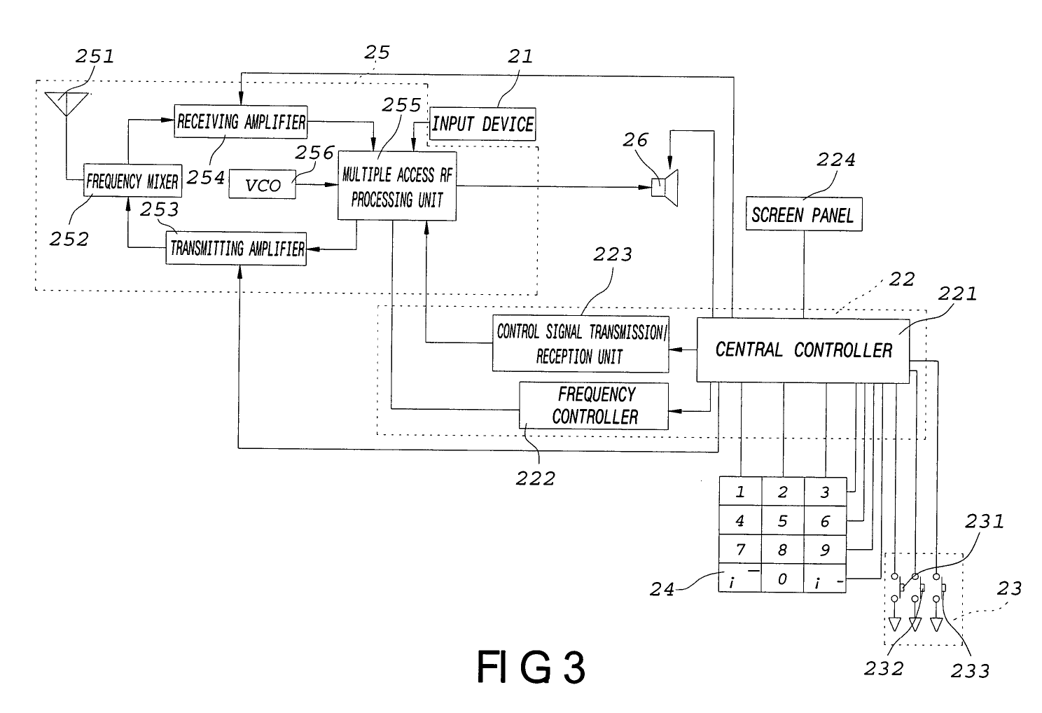

Please refer to FIG. 3. FIG. 3 is a circuit block diagram of the wireless earphone 2 according to the present invention. The wireless earphone 2 according to the present invention comprises an input device 21, a control unit 22, a switching unit 23, a keypad unit 24, a transceiver unit 25, and an output device 26.

The input device 21 may be a microphone for a user to input voice signals. The control unit 22 consists of a central controller 221, a frequency controller 222, and a control signal transceiver unit 223. The control unit 22 is the kernel of the wireless earphone 2. The central controller 221 includes a memory 2210. The keypad unit 24 having a plurality of input buttons for dialing is electrically connected to the central controller 221. The switching unit 23 is electrically connected to the control unit 22. The switching unit 23 comprises an audio switch 231, a frequency switch 232, and a wireless phone switch 233. The audio switch 231 may be used to adjust the volume of audio output signals. The frequency switch 232 is used to select different receiving frequencies. When a user pushes the wireless phone switch 233, the control unit 22 will judge whether the user has inputted a communication transmission password via the keyboard input part 134 of the cordless telephone 3 and whether or not it matches the communication transmission password stored on the memory 2210. If the inputted password is correct, the wireless earphone 2 communicates with the cordless telephone 3 and thus the wireless earphone 2 becomes a handset of the cordless telephone 3. If the inputted password is incorrect, the output device 26 will be sent a warning sound to notify the user of the error.

The transceiver unit 25 is electrically connected to the input device 21 and the control unit 22. The transceiver unit 25 consists of an antenna 251, a frequency mixer 252, a transmitting amplifier 253, a receiving amplifier 254, a multiple-access RF processing unit 255, and a voltage control oscillator 256. The transceiver unit 25 is controlled by the central controller 221 and communicates with the cellular phone base 1.

The output device 26 is electrically connected to the control unit 22. The output device 26 may be an earphone or a speaker. The output device 26 is used to output the signals received by the transceiver unit 25. The output device 26 is controlled by the central controller 221. The central controller 221 of the control unit 22 is electrically connected to a display panel 224 for displaying incoming calls.

Accordingly, when receiving a call, the cellular phone 4 transmits the voice signals to the transceiver unit 14 of the cellular phone base 1 through the cellular phone interface 12. At the same time, the cellular phone 4, which is controlled by the central controller 131, transmits the voice signals to the transceiver unit 25 of the wireless earphone 2. The voice signals received by the central controller 221 of the wireless earphone 2 will be transmitted to the output device 26, and then to a user. Likewise, the user can talk via the input device 21 of the wireless earphone 2. In this case, the voice signals are transmitted to the transceiver unit 25, and then transmitted to the transceiver unit 14 of the cellular phone base 1 under the control of the central controller 221, and then transmitted to the cellular phone 4 through the cellular phone interface 12 under the control of the central controller 131. Alternatively, the user can push the audio switch 231 of the switching unit 23 to adjust the volume. Also, the user can push the frequency switch 232 to select different frequency channels.

When the central controller 131 of the control unit 13 is connected to the telephone interface 11, the telephone interface 11 sends DTMF and MUT signals. At the same time, the central controller 131 triggers the contact C to connect with the contact B of the first electric switch 150 and the second electric switch 152, such that the multiple-access RF processing unit 145 is connected to the telephone interface 11. The user can dial via the keypad unit 24 of the wireless earphone 2. Signals are transmitted to the cellular phone base 1 and rectified at the telephone interface 11 and then inputted into the telephone 3. Accordingly, the wireless earphone 2 acts as a wireless earphone of the telephone 3.

To sum up, in accordance with the disclosed invention, the wireless earphone 2 not only prevents harm caused by high frequency signals but increases the integrity between the telephone 3 and cellular phone 4.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A cellular phone base capable of switching cellular phone and cordless phone communications, comprising:
a telephone interface connected to a telephone line, the telephone interface comprising:
a front circuit unit;
a solenoid switch unit connected to the front circuit unit for receiving an off hook signal which causes the solenoid switch unit to be turned on;
an optocoupler circuit unit receiving a warning signal supported by the front circuit unit to drive a speaker of the cellular phone; and
a transformer unit transmitting a voice signal provided by the front circuit unit to a voice output/input circuit via the solenoid switch and the optocoupler circuit unit;
a cellular phone interface wirelessly connected to the cellular phone;
a control unit installed in the cellular phone base, the control unit comprises a central controller, a frequency controller, and a control signal transceiver unit;
a transceiver unit connected to the control unit, the transceiver unit being under control of the central controller and communicating with a corresponding wireless earphone; and
a plurality of electric switches connected to the telephone interface, the cellular phone interface, the control unit, and the transceiver unit, the electric switches include a first electric switch and a second electric switch, the switch normally connects the transceiver unit with the cellular phone interface, and the central controller to control the electric switches such that the transceiver unit is connected to the telephone interface when the cordless telephone transmits a voice signal to the control unit via telephone interface.

2. The cellular phone base capable of switching cellular phone and cordless phone communications as claimed in claim 1 wherein the telephone interface is connected to a telephone line through a rectifying circuit.

3. The cellular phone base capable of switching cellular phone and cordless phone communications as claimed in claim 1 wherein the control unit further comprises a keypad unit having a plurality of buttons and a display panel to display calls.

4. The cellular phone base capable of switching cellular phone and cordless phone communications as claimed in claim 1 wherein the transceiver unit consists of an antenna, a SAW filter, a transmitting amplifier, a receiving amplifier, a multiple-access RF processing unit, and a voltage control oscillator (VCO).

5. A wireless earphone capable of switching cellular phone and cordless phone communications, comprising:
an input device for inputting voice signals;
a control unit installed in the wireless earphone, the control unit comprises a central controller, a frequency controller, and a control signal transceiver unit, the central controller includes a memory for storing a communication transmission password;
a switching unit connected to the control unit, the switching unit comprises an audio switch, a frequency switch, and a cordless phone switch;
a keypad unit connected to the control unit, the keypad unit comprising a plurality of buttons;
a transceiver unit connected to the input device and the central controller, the transceiver unit being under control of the central controller and communicating with a corresponding cellular phone base; and
an output device connected to the control unit, wherein the output device is used to transmit signals received by the transceiver unit under the control of the control unit.

6. The wireless earphone capable of switching cellular phone and cordless phone communications as claimed in claim 5, wherein the input device is a microphone.

7. The wireless earphone capable of switching cellular phone and cordless phone communications as claimed in claim 5, wherein the control unit is further connected to a display panel to display calls.

8. The wireless earphone capable of switching cellular phone and cordless phone communications as claimed in claim 5, wherein the transceiver unit consists of an antenna, a SAW filter, a transmitting amplifier, a receiving amplifier, a multiple access RF processing unit, and a voltage control oscillator (VCO).

9. The wireless earphone capable of switching cellular phone and cordless phone communications as claimed in claim 5, wherein the audio switch is for adjusting voice volume.

10. The wireless earphone capable of switching cellular phone and cordless phone communications as claimed in claim 5, wherein the frequency switch is for selecting different frequency channels.

11. The wireless earphone capable of switching cellular phone and cordless phone communications as claimed in claim 5, wherein the control unit judges whether the user has inputted the communication transmission password via the keyboard input part of the cordless telephone and whether the communication transmission password matches the communication transmission password stored on the memory, if the inputted password is correct, the wireless earphone communicates with the cordless telephone, if the inputted password is incorrect, the output device will be sent a warning sound to inform the user of the error.

12. The wireless earphone capable of switching cellular phone and cordless phone communications as claimed in claim 5, wherein the output device is an earphone or a speaker.
